(19) United States
(12) Patent Application Publication
(10) Pub. No.: US 2007/0281077 A1
(43) Pub. Date: Dec. 6, 2007

(54) Method for packaging integrated circuit dies

(76) Inventor: Lin Tiang Hock, Singapore (SG)

Correspondence Address: SLATER & MATSIL LLP, 17950 PRESTON ROAD, SUITE 1000, DALLAS, TX, 75252, US

(21) Appl. No.: 11/483,412

(22) Filed: Jul. 6, 2006

Related U.S. Application Data
(63) Continuation of application No. PCT/SG04/00426, filed on Dec. 24, 2004.

(30) Foreign Application Priority Data
Jan. 6, 2004 (SG) 200400083-2

(51) Int. Cl. B05C 3/12

(52) U.S. Cl. 427/98.6; 118/420

(57) ABSTRACT

A packaging method is proposed in which two substrates 23a, 23b, each carrying at least one die 21a, 21b, are placed back-to-back in a mold chase 22 with their surfaces 20a, 20b, which carry dies, facing into respective cavities 24a, 24b. Each cavity is fed liquid resin through at least one respective channel 28a, 28b that introduces the resin into the cavity at a location spaced from the corresponding substrate. Thus a resin body 29a, 29b is formed on each of the substrates 23a, 23b. Thus, a package is produced from each of the two substrates 23a, 23b in a single molding operation. The invention is particularly suitable for producing flip-chip-in-package type packages.

This application is a continuation of co-pending International Application No. PCT/SG2004/000426, filed Dec. 24, 2004, which designated the United States and was published in English, and which is based on Singapore Application No. 200400083-2 filed Jan. 6, 2004, both of which applications are incorporated herein by reference.

### TECHNICAL FIELD

The present invention relates to methods for creating packages to packages produced by the methods.

### BACKGROUND

Recently there has been increasing interest in “flip-chip in package” (FCIP) components, that is integrated circuits in which the die is interconnected to the lead structure of the package as a flip-chip. The die is formed with electrical contacts on a surface that is turned towards a substrate, and connected to it such that the electrical contacts on the die are electrically connected to respective contracts of the substrate. Normally this is done by providing a ball grid array (BGA) on the surface of the die. After the die is connected to the substrate, a resin compound is molded over the die and the substrate to form a package. Optionally, there may be multiple dies provided within a single package, at respective positions on a shared substrate. The substrate contains internal electrical connections, including electrical connections that define parts of electrical paths from at least some of the contacts of the ICs to respective contacts on the exterior of the package.

The molding process used in forming such an FCIP is illustrated in FIG. 1. As shown in FIG. 1(a), a plurality of dies 1 are provided on a substrate 3, and electrical contacts on the dies 1 are connected to respective electrical contacts on the substrate 3 by respective eutectic solder balls 5.

In the molding operation, a resin body 9 is formed covering the dies 1. This is done, as shown in FIG. 1(b), by positioning the substrate 3 carrying the dies 1 into a mold chase 2 with the surface of the substrate 3 carrying the dies 1 facing into a cavity 4 in the mold chase 2. A block 6 is inserted in the mold chase 2 on the rear surface of the substrate to hold it firmly in position. Liquid resin compound is injected into the cavity 4 through a channel 8 in the mold chase 2. Conventionally, this channel 8 leads to an area 7 on the side of the substrate. The resin is then allowed to harden, and the substrate 3 is removed from the mold chase 2. The portion of the resin that was in the cavity is retained on the side of the substrate as a “gate” 11 over a side portion 7 of the substrate 3 referred to as a “gate land.” This formation is shown in FIG. 1(c). The point 13 corresponds to the location where the channel in the mold opened into the mold cavity, and as can be seen it was on the surface of the substrate. Further solder balls (not shown) are then provided on the substrate 3 on its surface opposite the dies 1 to form electrical connections out of the package.

There are several disadvantages with this molding technique. In particular, debris from the molding operation and the degating may become attached to the surface of the substrate 3 opposite the dies 1, and in particular stick on the ball pads there. This may result in the electrical connections from the lower surface of the substrate 3 being lost.

Secondly, substrates are now becoming thinner, which makes handling them during the molding operation progressively more difficult.

Another disadvantage of the known technique is that the gate 11 has to be removed from the package before the package is used (“degating”). The degating operation is not straightforward, because the resin may adhere strongly to the substrate 3 in the gate land 7. Furthermore, the main resin body 9 is connected to the gate 11, and the degating operation may tear it from the substrate 3.

### SUMMARY OF THE INVENTION

The present invention aims to provide a new and useful method for packaging an IC, and IC packages, which are the result of the method.

In general terms, the invention proposes that two substrates each carrying at least one die are placed “back-to-back” in the mold, i.e., with their surfaces that carry the dies facing away from each other and facing into respective cavities.

In a first aspect, the invention provides a package fabrication method that includes providing two substrates, each carrying one or more dies on a first face; arranging the two substrates with second faces of the respective substrates, opposite the first surfaces, abutting each other; placing the two substrates together into a mold, with the first surfaces of the substrates facing into respective cavities; introducing liquid resin into each of the cavities through at least one channel formed in the mold, then at least one channel having an outlet spaced from the substrates; allowing the liquid resin to solidify to form respective resin bodies on the first surfaces of the substrates; and removing the substrates from the mold.

The invention may provide a number of advantages. Firstly, the number of packages that can be produced in a single molding operation is doubled, dramatically producing productivity.

Secondly, the need to provide a mold chase is removed, since the backs of the substrates are supported by the other substrate.

This leads to a third advantage, which is that since the substrates support each other, such that the combination of the two substrates is more rigid than a single substrate, each of the substrates can be thinner than in conventional systems without risk of them being damaged.

Fourthly, since the back of each substrate is covered by the back of the other substrate, it is very hard for debris to reach either of these surfaces, so that there is less risk of it becoming attached there.

Further, the channel(s) that introduce(s) resin into the cavity or cavities open into the cavity at a location spaced from the surface of the substrate. Thus, the gates are not formed directly on the substrate, and do not become adhered to it. This makes the degating operation much simpler.

Note that the advantages above may be achieved by a relatively minor modification of existing molding techniques, since typically only the mold chase and the handler for placing the substrates into the mold cavity need to be modified.

The feeding of resin material into the cavities can be accomplished in various ways within the scope of the invention. It is possible, for example, to provide a respective channel for each cavity. Alternatively, the two cavities may be arranged to communicate with each other (e.g., by a hole formed in the substrates, or by the arrangement of the substrates and the mold leaving a passageway between them). In this case, resin may only be fed into one of the cavities and then passes from that cavity into the other cavity.

Furthermore, since the gates are not formed on the substrate none of the substrate area is wasted as gate lands. Thus, dies can be located close to the edge of the substrate (or at least closer than in the conventional system). From one point of view, this means that for a given number of dies the area of the required substrate is less, leading to reduced costs (particularly since typically the substrate is selectively gold plated). From another point of view, for a given size of the substrate, this means that the proportion of the substrate that can be utilized is increased.

### BRIEF DESCRIPTION OF THE DRAWINGS

Preferred features of the invention will now be described, for the sake of illustration only, with reference to the following figures in which:

FIG. 1, which includes FIGS. 1(a) to 1(c), shows in cross-section steps of a known packaging process;

FIG. 2 shows a first step of a packaging method, which is an embodiment of the invention;

FIG. 3 shows, in cross-section, a mold for use in the method of FIG. 2;

FIG. 4 shows two packages produced by the molding method of FIG. 2;

FIG. 5 shows a molding step as a comparative example to the invention;

FIG. 6 shows the molding step in a second embodiment of the invention; and

FIG. 7 shows the molding step in a third embodiment of the invention.

### DETAILED DESCRIPTION OF ILLUSTRATIVE EMBODIMENTS

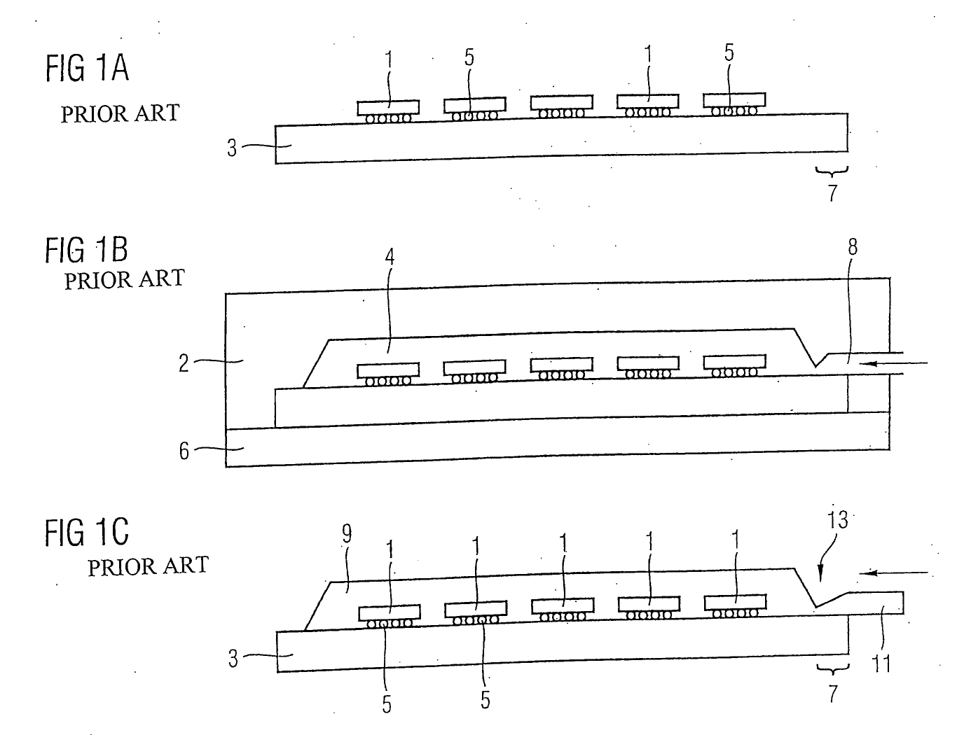

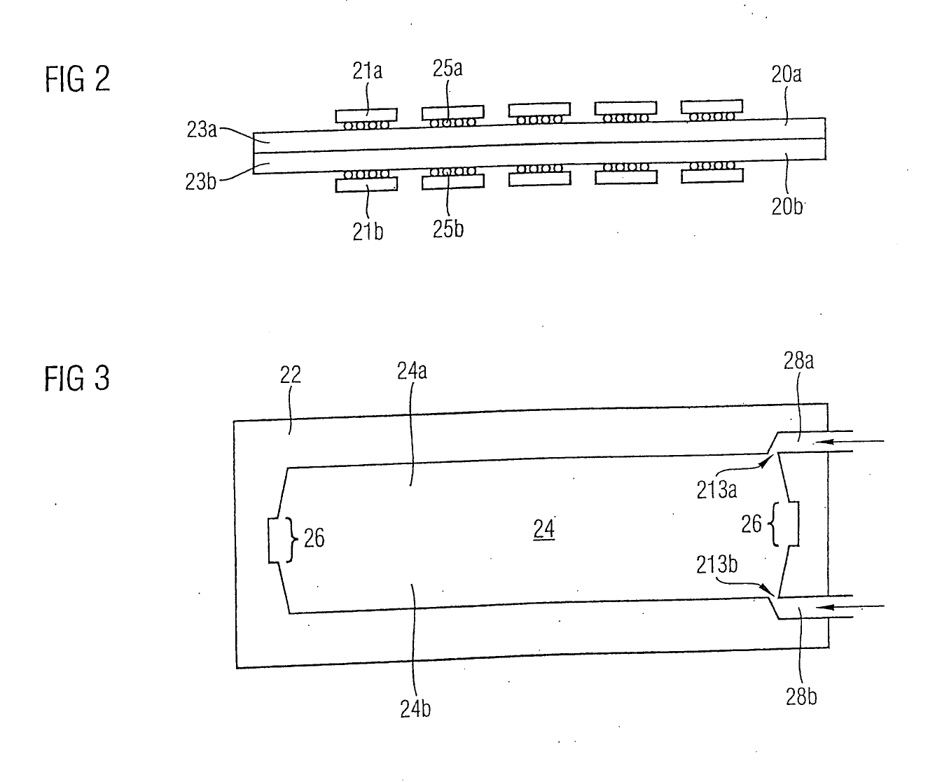

Referring to FIG. 2, the first step of a method which is an embodiment of the invention is shown. In the molding method, the two substrates 23a, 23b are each of the kind shown in FIG. 1. These substrates may, for example, be printed circuit boards, or otherwise include electrical circuitry, extending, for example, parallel to the major surfaces of the substrate. Their surfaces 20a, 20b carry dies 21a, 21b connected to the substrates 23a, 23b by a ball grid array (BGA), e.g., of eutectic solder balls 25a, 25b. The substrates 23a, 23b are placed in a back-to-back configuration, so that their back faces are in contact, and their front faces 20a, 20b, carrying dies 21a, 21b, are directed in opposite directions.

As shown in FIG. 3, the substrates 23a, 23b are placed in this configuration into a mold cavity 24 in a mold chase 22, such that the cavity 24 is divided into two cavities 24a, 24b (in FIG. 3, these are respectively the upper and lower portions 24a, 24b of the cavity 24). The faces 20a, 20b of the substrates 23a, 23b are directed into respective cavities 24a, 24b of the mold. The edges of the substrates 23a, 23b are held in place by formations 26 of the mold chase 22. In this example, the formations 26 serve as a substrate support in the cavity 24. This handling operation is easier than placing the substrate 3 of FIG. 1 into the mold, because the substrates 23a, 23b support each other; this means that they may be thinner than the substrate 3 for the same handling difficulty.

Note that the mold chase 22 may be formed in several ways, and according to how it is designed, the insertion of the substrates 23a, 23b into the mold chase 22 is done differently. For example, the mold chase 22 may be formed in two parts, which are fixed together to form the configuration shown in FIG. 3, and in this case the substrates 23a, 24b may be positioned between the two parts of the mold chase 22 before those two parts are brought together and mutually attached.

Note that mold block is required when the substrates 23a, 23b are in the mold, because the back face of each of the substrates 23a, 23b is secured by being held in place by the back face of the other one of the substrates 23a, 23b.

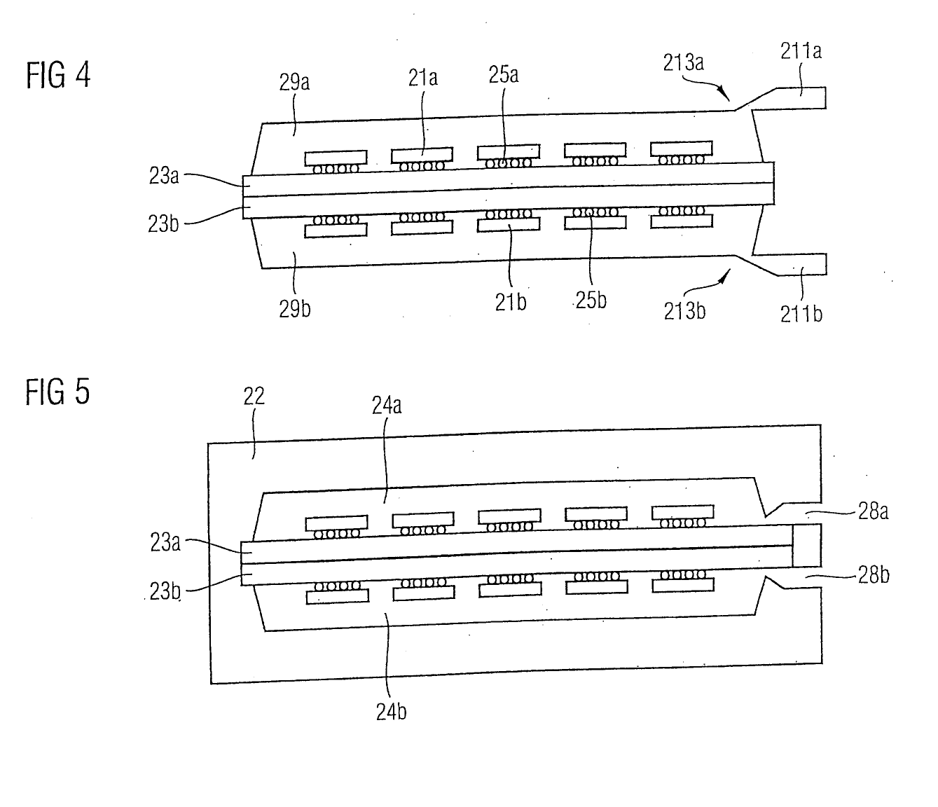

The cavities 24a, 24b of the mold are each fed liquid resin through respective channels 28a 28b (at least one such channel per cavity 24a, 24b), which exit into the cavities 24a, 24b at locations 213a, 213b spaced from the corresponding first surfaces 20a, 20b of the substrates 23a, 23b, and indeed substantially at the face of the cavity 24a, 24b furthermost from the substrates 23a, 23b. The resin is then hardened, to form respective resin bodies 29a, 29b (see FIG. 4). This forms gates 211a, 211b, including narrowed points 213a, 213b where the channels join the mold cavities. During this process, the respective back surfaces of the substrates 23a, 23b are covering each other, and so prevent each other from becoming contaminated with resin debris. Thus, in a further processing step conductive elements such as eutectic solder balls can be provided on the back surfaces of the substrates 23a, 23b to provide electrical connections out of the package. The solder balls make good electrical contact with the substrates 23a, 23b (or rather with electrical connections provided within them, e.g., according to conventional methods) because there is little or no resin debris on those surfaces.

The substrates 23a, 23b and respective resin bodies 29a, 29b are now removed from the mold, as shown in FIG. 4. The gates 211a, 211b are easily removed during this process since they are not adhered to the substrates 23a, 23b. This results in two respective packages. Thus, in a single molding operation, two packages are produced. This leads to a doubling of the production rate compared to FIG. 1 (measured in units-per-hour).

Note that this means that, in comparison to FIG. 1, the areas of the substrates 23a, 23b corresponding to the area 7 of the substrate 3 are unused, which in turn means that these areas of the substrates may be omitted (saving cost). Alternatively, dies 21a, 21b may be provided in greater numbers than on the substrate of FIG. 1. Furthermore, the gates 211a, 211b may be removed easily compared to the gate 11 of FIG. 1, because they are not attached to the substrates 23a, 23b.

Although not shown in FIG. 4 the mold chase 22 may include pins located in it to aid the removal of the package from the mold chase 22. These pins have a retracted state in which they do not intrude into the cavities 24a, 24b, but following the molding operation the pins are urged into respective ones of the cavities 24a, 24b to force the packages out of the mold chase 22. The design of these pins may closely follow those already in widespread use in this field.

Optionally, a thin plate (not show) may be provided between the substrates 23a, 23b, preferably extending over the whole of their facing back surfaces and optionally extending out beyond the edges of the substrates 23a, 23b. This plate allows the substrates 23a, 23b to be removed from the mold chase 22 after the molding operation, since the mold may be handled rather than the substrates.

FIG. 5 shows a comparative example to the present invention. Elements having corresponding meaning are denoted by the same reference numerals. In contrast to the present invention, the channels 28a, 28b are located adjacent the substrates 23a, 23b. This option is not preferred since it means that gates are formed on the surfaces of the substrate, with the disadvantages explained above.

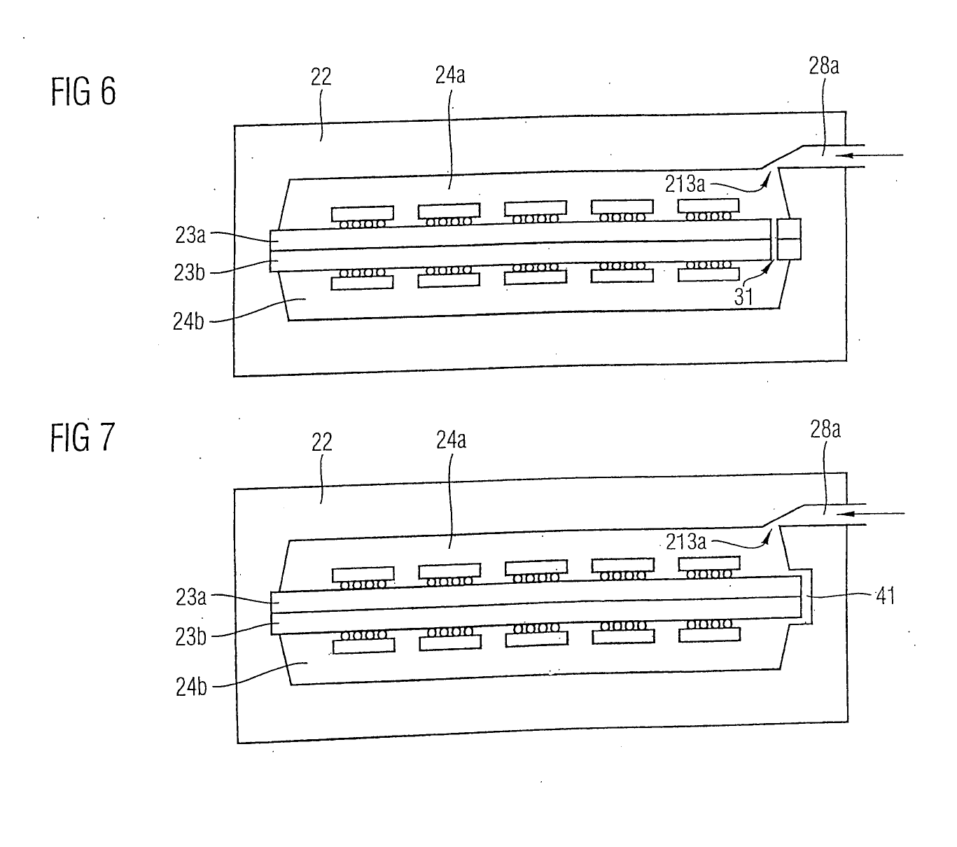

FIG. 6 shows a second embodiment of the invention, which is a variant of the first embodiment. Elements having corresponding meaning are denoted by the same reference numerals. The second embodiment is shown at the time of the molding step. There are two variations between this embodiment and the first embodiment. Firstly, there is only one channel 28 for resin to enter the mold chase 22, opening into the cavity 24a. Secondly, the pair of substrates 23a, 23b are provided with one or more through holes 31 (e.g., holes (e.g., circular, when viewed from the top or bottom of FIG. 6) in each of the two substrates 23a, 23b, which are in register with each other when the substrates 23a, 23b are in the mold chase 22) so that resin flowing into the cavity 24a is transmitted into the cavity 24b to fill both cavities.

Finally, FIG. 7 shows a third embodiment of the invention, which is a variant of the second embodiment. In this embodiment, the substrates 23a, 23b cooperate with the mold chase 22 to define at least one passageway 41 around an edge of the substrates 23a, 23b. This makes the through holes 31 unnecessary. It is to be understood that the passageway 41 is typically much shorter in the direction into the page than the edges of the substrates 23a, 23b; in other words, the passageway is preferably narrow in the directions perpendicular to the flow direction of resin through it.

Although only three embodiments of the method are illustrated, many variations are possible within the scope of the invention, as will be clear to a skilled reader.

What is claimed is:

1. A package fabrication method comprising:
providing two substrates, each carrying one or more dies on a first surface;
arranging the two substrates with second surfaces of the respective substrates, opposite the first surfaces, abutting each other;
placing the two substrates together into a mold, with the first surfaces of the substrates facing into respective cavities;
introducing liquid resin into each of the cavities through at least one channel formed in the mold, the at least one channel having an outlet spaced from the substrates;
allowing the liquid resin to solidify to form respective resin bodies on the first surfaces of the substrates; and
removing the substrates from the mold.

2. The method according to claim 1, wherein each of the dies comprises a flip-chip.

3. The method according to claim 1, wherein the liquid resin is introduced into a first one of the cavities through the at least one channel and the two cavities communicate, the liquid resin flowing from a first of the cavities to the other cavity.

4. The method according to claim 1, wherein the liquid resin is introduced into each of the cavities through two channels formed in the mold.

5. The method according to claim 4, wherein a first of the two channels is located at a side surface of the mold adjacent a top surface of the mold and wherein a second of the two channels is located at the side surface of the mold adjacent a bottom surface of the mold, the top surface and the bottom surface of the mold extending substantially parallel to the first surfaces of the substrate.

6. The method according to claim 1, further comprising, after removing the substrates from the mold, forming a plurality of solder balls on the second surfaces of the substrates.

7. The method according to claim 1, further comprising, for each substrate, removing a gate portion of the resin from a remaining portion of the resin bodies, wherein the gate portion is spaced from the substrate so that removing the gate portion comprises the gate portion from the remaining portion without needing to remove the gate portion from the substrate.

8. A package produced by the method according to claim 1.

9. A package fabrication method comprising:
providing a mold that includes a mold housing defining a chamber and at least one channel for introducing liquid resin into the chamber, the mold housing including an upper surface, a lower surface opposed to the upper surface, and a side surface extending between and being shorter than the upper and lower surfaces, wherein the at least one channel is located within the side surface adjacent the upper surface;
providing two substrates, each substrate carrying one or more dies on a first surface;
arranging the two substrates with second surfaces of the respective substrates, opposite the first surfaces, abutting each other;
placing the two substrates together into the chamber, with the first surfaces of the substrates facing into respective cavities of the chamber;
introducing liquid resin into each of the cavities through the at least one channel such that the liquid resin is introduced from the channel at a point that is spaced from both of the substrates;
allowing the liquid resin to solidify to form respective resin bodies on the first surfaces of the substrates; and
removing the substrates from the mold.

10. The method of claim 9, wherein the at least one channel comprises exactly one channel such that the liquid resin flows from one cavity to the other cavity via at least one hole defined within the two substrates.

11. The method of claim 9, wherein the at least one channel comprises exactly one channel such that the liquid resin flows from one cavity to the other cavity via a space between an inner wall of the chamber and the two substrates.

12. The method of claim 9, wherein the at least one channel comprises first and second channels, the first channel located within the side surface adjacent the upper surface and the second channel located within the side surface adjacent the lower surface such that both channels are spaced from the substrates.

13. An apparatus for use in packaging two substrates that each include at least one die, the mold comprising:
a mold housing defining a chamber;
a substrate support within the chamber, the substrate support arranged to support the two substrates within the chamber so that the substrates divide the chamber into first and second cavities; and
at least one channel for introducing liquid resin into the first and second cavities, the at least one channel being arranged relative to the substrate support such that the at least one channel is spaced from the substrates.

14. The apparatus of claim 13, wherein the mold housing includes an upper surface, a lower surface opposed to the upper surface, and a side surface extending between and being shorter than the upper and lower surfaces, wherein the at least one channel is located within the side surface adjacent the upper surface.

15. The apparatus of claim 14, wherein the at least one channel comprises exactly one channel.

16. The apparatus of claim 14, wherein the at least one channel comprises first and second channels, the first channel located within the side surface adjacent the upper surface and the second channel located within the side surface adjacent the lower surface.

17. The apparatus of claim 13, wherein the substrate support comprises formations within sidewalls of the chamber.

18. The apparatus of claim 13, wherein the at least one channel comprises exactly one channel such that the liquid resin flows from the first cavity to the second cavity via at least one hole defined within the two substrates.

19. The apparatus of claim 13, wherein the at least one channel comprises exactly one channel such that the liquid resin flows from the first cavity to the second cavity via a space between an inner wall of the chamber and the two substrates.

20. The apparatus of claim 13, wherein the at least one channel comprises two channels, each of which is arranged relative to the substrate support such that both channels are spaced from the substrates.
